(19) United States
(12) Patent Application Publication
(10) Pub. No.: US 2022/0176583 A1
(43) Pub. Date: Jun. 9, 2022

(54) DEVICE AND METHOD FOR COATING WORKPIECES

(71) Applicant: HOMAG GmbH, Schopfloch (DE)

(72) Inventors: Reiner GÖTZ, Horb-Diessen (DE); Yimin GAN, Rottenburg am Neckar (DE); Harald RIEGER, Waldachtal (DE)

(21) Appl. No.: 17/602,241

(22) PCT Filed: Apr. 6, 2020
(86) PCT No.: PCT/EP2020/059759

§ 371 Date: Oct. 7, 2021

(30) Foreign Application Priority Data
Apr. 8, 2019 (DE) 10 2019 109 128.4

(51) Int. Cl. B27D 5/00; B29C 63/00; G10K 11/162

(52) U.S. Cl. CPC B27D 5/003; B29C 63/0026; B29C 2063/485; G10K 11/162; B29C 63/0004

(57) ABSTRACT

A device for coating workpieces preferably consisting at least in parts of wood, wood materials, plastic, aluminium or the like, comprises: a feed device for feeding a coating material; a pressing device for pressing the coating material onto a surface of a workpiece; a conveying device for inducing a relative movement between the pressing device and the respective workpiece; and an activation device for activating an adhesive on a coating material fed in the feed device and/or for activating an adhesive on a surface of a workpiece to be coated. The activation device comprises at least one supply line for supplying an activation medium as well as a nozzle body having an inlet duct and an outlet region. The activation device comprises at least one acoustic element that is configured to reduce the sound pressure resulting from the flow of the activation medium and/or to effect a frequency shift.

### TECHNICAL FIELD

The invention relates to a device for coating and/or activating preferably plate-shaped workpieces consisting at least in parts of wood, wood materials, plastic, aluminium or the like. The invention furthermore relates to a method for coating and/or activating preferably plate-shaped workpieces consisting at least in parts of wood, wood materials, plastic, aluminium or the like.

### PRIOR ART

In the furniture and components industry, for example, workpieces are often provided with a coating material on one of their surfaces, for instance an edge. The coating material is usually attached by means of a suitable adhesive applied to the workpiece in the form of a hot-melt adhesive, for example.

Known from DE 10 2006 056010 is a coating method in which an adhesive provided on the coating material or the workpiece is heated or activated using a laser.

WO 2016 151038 discloses an activation device for a device for applying in particular adhesive-free, heat-activated edge strips to plate-like workpieces. A nozzle arrangement for heating an edge strip is furthermore disclosed in WO 2017 114792.

One disadvantage of the above-mentioned device for applying adhesive-free, heat-activated edges is the fact that a high sound pressure results from the flow of the activation medium, which is usually heated air. For reasons of operational safety, noise protection cladding must accordingly be provided, which makes it more difficult to access the respective machine area and incurs additional costs.

### DESCRIPTION OF THE INVENTION

An object of the invention is to provide a simple and efficient way of increasing operational safety when coating workpieces.

According to the invention, this object is solved by a device according to claim 1 or a method according to one of claim 24 or 25. Preferred embodiments are specified in the sub-claims.

A device according to the invention for coating workpieces preferably consisting at least in parts of wood, wood materials, plastic, aluminium or the like, comprises: a feed device for feeding a coating material; a pressing device for pressing the coating material onto a surface of a workpiece; a conveying device for inducing a relative movement between the pressing device and the respective workpiece; and an activation device for activating an adhesive on a coating material fed in the feed device and/or for activating an adhesive on a surface of a workpiece to be coated. The activation device comprises at least one supply line for supplying an activation medium as well as a nozzle body having an inlet duct and an outlet region. The activation device furthermore comprises at least one acoustic element that is configured to reduce the sound pressure resulting from the flow of the activation medium and/or to effect a frequency shift.

The acoustic element may be configured as a sound-absorbing element and/or as a resonator. In the present context, a resonator is a device that is tuned to one or more specific frequencies such that in the case of broadband excitation, it substantially only oscillates at the specific frequency or frequencies.

Owing to the fact that the device according to the invention comprises at least one corresponding acoustic element, the sound pressure of the sound resulting from the flow of the activation medium can be reduced or the frequency of this sound can be changed such that the need for noise protection cladding is eliminated.

In an advantageous further development of the invention, the cited device may furthermore be configured such that the acoustic element is arranged at at least one of the locations: supply line of the activation device; inlet duct of the nozzle body; outlet region of the nozzle body. The activation device may further comprise an activation medium heating device and/or an activation medium cooling device and/or an activation medium discharge duct, and at least one acoustic element may be arranged in one or more of these devices.

An activation medium heating device may furthermore comprise an energy source. If at least one acoustic element is arranged in the activation medium heating device, it may be attached to the energy source or be arranged inside the energy source.

If the acoustic element is arranged at the outlet region of the nozzle body, the configuration may also be described such that the acoustic element also forms the outlet region of the nozzle body. This is in particular the case if the acoustic element is recessed in the nozzle body in a flush-mounted manner (force fit/form fit) and/or is cohesively bonded thereto.

The cited positions can be considered advantageous since they do not fall within the working area of an operator and therefore no disruption of operating procedures is to be expected.

According to the invention, the acoustic element may comprise a single-layer or multi-layer fabric and/or a honeycomb structure. While the cited types of fabric are characterised in particular by the fact that they are available at low cost, a honeycomb structure may have advantages in terms of mechanical rigidity. In particular in the case of high flow velocities of the activation medium, a high mechanical rigidity can be an important requirement for the components installed in the acoustic element.

Two-dimensional or three-dimensional sequences of n-corners, circles or ellipses can be cited as examples of a honeycomb structure. Furthermore, a one-dimensional or multi-dimensional stacking of de Laval nozzles can also be associated with the term honeycomb structure.

The cited device may be configured such that the acoustic element contains a plurality of grid elements which together form a grid structure with openings, whereby a grid element may be formed by displacement, for example parallel displacement, of a planar cross-section preferably perpendicular to the cross-sectional plane. A grid element may furthermore or alternatively also be configured as a rotationally symmetrical body. A first plurality of grid elements may form an angle of between 20° and 90°, preferably between 45° and 90° and particularly preferred between 85° and 90°, relative to a second plurality of grid elements. The grid elements may comprise notches which are configured such that grid elements that are each angled relative to each other can be inserted into each other. The grid elements that are each angled relative to each other can be connected to one another by clamping and/or welding, for example. Alternatively or additionally, they may be held in position by a frame and/or support structure.

Similar to the honeycomb structure mentioned above, the arrangement of the grid elements within the acoustic element may promote high mechanical strength.

In an advantageous further development of the invention, a grid element may comprise a round portion and a pointed portion substantially opposite thereto. The cross-section of the grid elements may therefore also be described as wing-shaped or drop-shaped. The side of the grid element against which the activation medium flows is preferably round. This embodiment is advantageous in that owing to the low drag coefficient of the wing or drop shape, the drag of the acoustic element in question can be reduced and the energy efficiency of the device in question can thus be improved.

The acoustic element may further be configured such that a plurality of grid structures, honeycomb structures and/or sintered structures are stacked such that the openings (15) thereof are at least partially aligned with one another and/or at least partially offset from one another. Such a stacking allows a plurality of possible layerings, as a result of which the properties of the acoustic element can be specifically tailored to a predetermined requirement profile.

Furthermore, the acoustic element may comprise a plurality of spheres. These may be arranged, for example, in a substantially primitive cubic, body-centred cubic, face-centred cubic or hexagonal close-packed sphere packing. Such sphere packings comprise cavities that are fluidically connected with one another, through which an activation medium can flow. Owing to the arrangement of the cavities and the spheres, diffuse sound reflections and/or absorptions can be achieved, by means of which the sound pressure resulting from the flow of the activation medium can be reduced in a particularly advantageous manner.

As an alternative or in addition to the aforementioned spheres, the sound-absorbing element may comprise a plurality of streamlined bodies, with a streamlined body comprising a substantially hemispherical end and a pointed end opposite thereto. The streamlined bodies are preferably arranged in the acoustic element such that the activation medium flows against the substantially hemispherical ends of the streamlined bodies. A streamlined body axis extends through the hemispherical end and the pointed end of a streamlined body. The streamlined body axes of all streamlined bodies of the acoustic element are advantageously arranged such that they are substantially parallel.

The embodiment with streamlined bodies may be advantageous as regards occurring flow losses, in particular pressure losses and losses in flow velocity.

Since heated gases may be used as the activation medium, the device according to the invention may advantageously be developed further such that the acoustic element or parts of the acoustic element are made of a material that is suitable for continuous use at temperatures of up to 900° C., but preferably up to 500° C. The acoustic element or parts of the acoustic element may specifically be formed of a metal and/or ceramic material.

Manufacture of the acoustic element or at least parts of the acoustic element can advantageously be carried out by means of a casting process, a sintering process and/or an additive process. While a casting or sintering process is associated with comparatively low manufacturing costs, an additive manufacturing process in particular allows the production of complex geometries.

An acoustic element according to a further preferred embodiment comprises an inner conduit having an axis and an outer conduit arranged substantially concentric to this axis. The outer conduit has a larger cross-section than the inner conduit. The inner conduit and the outer conduit overlap in a first length region. The inner conduit is open at a first end and closed at an end substantially opposite thereto. The outer conduit is open at a second end and closed at an end substantially opposite thereto. The inner conduit has through-holes in its lateral surface that are configured to bring the first end into fluidic connection with the second end. According to the invention, a sound-absorbing material is arranged in the first length region in the cited embodiment.

In an advantageous further development of the above-mentioned embodiment, the sound-absorbing material may be arranged on the inner surface of the outer conduit. In addition, a plurality of structures substantially tapering in the direction of the conduit axis may be formed on a side of the sound-absorbing material facing the conduit axis. The sound-absorbing material may be a porous material.

The structure of the sound-absorbing element according to the preferred embodiment described above is characterised by a compact design suitable for arrangement in conduits. Porous materials furthermore exhibit mostly diffuse sound reflection behaviour, which, in the present context, can also have a beneficial effect on sound pressure and frequency.

Furthermore, a conduit lined on its inside with a sound-absorbing material and/or a resonator material may also be used as the sound-absorbing element. The sound-absorbing element may also be a conduit made of a sound-absorbing material and/or a resonator material. The entire supply line of the activation device may advantageously be formed of a sound-absorbing material and/or a resonator material.

The acoustic element arranged in the inlet duct of the nozzle body and/or the acoustic element arranged at the outlet region of the nozzle body may be attached to the nozzle body with a force fit, a form fit and/or a cohesive fit.

However, just as conceivable is an embodiment in which the acoustic element arranged in the inlet duct of the nozzle body and/or the acoustic element arranged at the outlet region of the nozzle body is configured integrally with the nozzle body. Compared to a differential design, the integral design leads to a reduction in the number of device-related components and can thus be associated with reduced manufacturing costs.

If the acoustic element is arranged in the supply line of the activation device, a force-fit, form-fit or cohesive-fit connection to the supply line may be provided. While the force-fit connection, for example by press-fitting or clamping, is usually associated with low manufacturing costs, the form-fit connection may offer advantages in terms of accessibility or replaceability as part of a maintenance operation. The cohesive-fit design, which can be produced using an additive manufacturing process, a casting process or a welding process, for example, can in turn increase the design freedom as regards the geometry of the acoustic element.

In an advantageous manner, the acoustic element arranged at the outlet region of the nozzle body may be recessed in the nozzle body in a flush-mounted manner. Collisions with the coating material or the workpiece are prevented in this manner. Irrespective of whether the acoustic element arranged at the outlet region of the nozzle body is recessed in the nozzle body in a flush-mounted manner or is placed thereon, the connection between the acoustic element and the nozzle body may be a force-fit, form-fit and/or cohesive-fit connection.

If the acoustic element comprises a fabric, a grid structure and/or a honeycomb structure, it is particularly advantageous for the mesh size of the respective structure or at least one of the structures to be less than the value 5000 μm, preferably less than the value 1000 μm, and particularly preferred less than the value 500 μm. The mesh size refers to the three-dimensional extension of a cavity in a solid-state structure, such as a grid or honeycomb structure, or to the two-dimensional distance between fibres or wires of a fabric.

According to the invention, a method is furthermore provided for coating and/or activating workpieces preferably consisting at least in parts of wood, wood materials, plastic, aluminium or the like. The method according to the invention is carried out with a device according to the invention as described above and comprises the following steps:
Inducing a relative movement between the pressing device and the respective workpiece by means of the conveying device;
Feeding the coating material by means of the feed device;
Applying and/or activating an adhesive on a coating material fed in the feed device and/or a surface of a workpiece to be coated by means of the activation device.

Depending on the embodiment of the device according to the invention, comparable advantages can be assigned to the method according to the invention as described above.

According to the invention, a method is furthermore provided for coating and/or activating workpieces preferably consisting at least in parts of wood, wood materials, plastic, aluminium or the like. The method according to the invention is carried out with a device according to the invention as described above, the device according to the invention furthermore comprising a sensor for measuring a measurement parameter. The method comprises at least the steps of: measuring a measurement parameter; and changing a working parameter based on the measured measurement parameter.

A temperature, an atmospheric pressure, a sound pressure, a sound frequency, a fluid viscosity or a Reynolds number may, for example, be specified as measurement parameters. Working parameters may be, for example, a feed rate, for instance a feed rate of a workpiece, a flow rate and/or a heating power or activation energy. In the case of a cooled activation medium, the working parameter may also be a cooling power. Within the framework of the method in question, one or more working parameters may furthermore also be changed based on one or more measurement parameters.

The latter method may advantageously lead to the used device, for example using a control unit, independently providing the optimal conditions for an operator in each case. These optimal conditions may in particular be conditions relating to the operational safety, ergonomics and/or productivity of the device.

### BRIEF DESCRIPTION OF THE FIGURES

FIG. 1 shows an embodiment of a device for coating workpieces as according to the prior art;

FIG. 2 shows a first embodiment of a device for coating workpieces as according to the invention;

FIG. 3 shows a second embodiment of a device for coating workpieces as according to the invention;

FIG. 4 shows a third embodiment of a device for coating workpieces as according to the invention;

FIG. 5 shows a fabric structure for an acoustic element according to the invention;

FIG. 6 shows a grid structure for an acoustic element according to the invention;

FIG. 7a shows a first embodiment of a grid element for a grid structure for an acoustic element according to the invention;

FIG. 7b shows a second embodiment of a grid element for a grid structure for an acoustic element according to the invention;

FIG. 8a shows an axial cross-section of a second advantageous embodiment of an acoustic element according to the invention;

FIG. 8b shows an axial cross-section of a third advantageous embodiment of an acoustic element according to the invention;

FIG. 9a shows components of a third advantageous embodiment of an acoustic element according to the invention;

FIG. 9b shows components of a fourth advantageous embodiment of an acoustic element according to the invention;

FIG. 10 shows a component of a fifth advantageous embodiment of an acoustic element according to the invention;

FIG. 11a shows a first arrangement according to the invention of the component of the fifth embodiment of an acoustic element according to the invention;

FIG. 11b shows a second arrangement according to the invention of the component of the fifth embodiment of an acoustic element according to the invention.

### DETAILED DESCRIPTION OF PREFERRED EMBODIMENTS

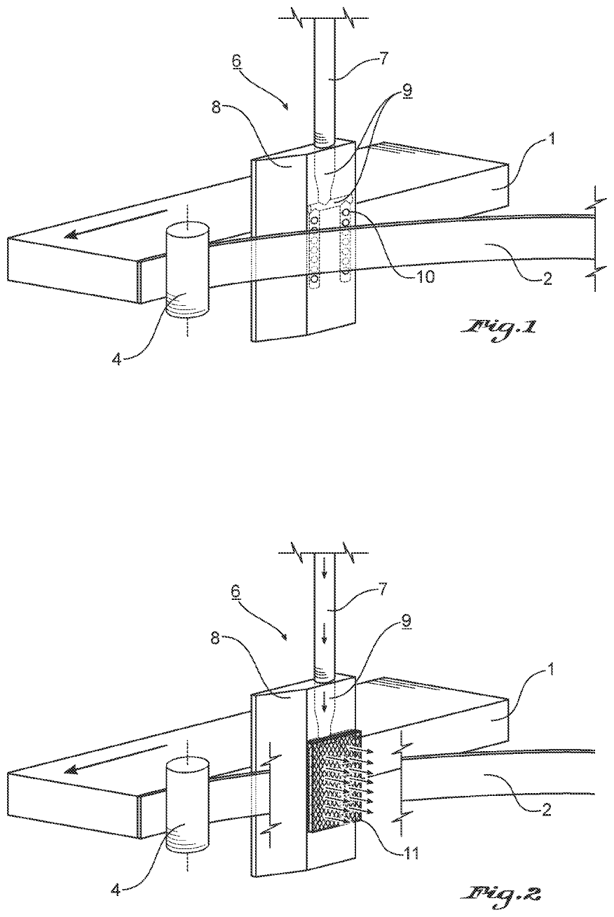

FIG. 1 shows an embodiment of a device for coating a workpiece 1 as according to the prior art. The shown device comprises: a feed device 3 (not shown) for feeding a coating material 2; a pressing device 4 for pressing the coating material 2 onto a surface of a workpiece 1; a conveying device 5 (not shown) for inducing a relative movement between the pressing device 4 and the respective workpiece 1; as well as an activation device 6 for activating an adhesive on a coating material 2 fed in the feed device 3. The activation device comprises a supply line 7 as well as a nozzle body 8. An inlet duct 9 or a system of inlet ducts 9 was introduced into the nozzle body. The nozzle body 8 furthermore comprises an outlet region 10, which in the present case is configured as a plurality of nozzles 10.

The embodiment of the present invention shown in FIG. 2 differs from the device of FIG. 1 in that an acoustic element 11, configured as a sound-absorbing element and/or resonator, is additionally arranged at the outlet region 10 of the nozzle body 8.

The embodiment of the present invention shown in FIG. 3 differs from the device of FIG. 1 in that an acoustic element 11, configured as a sound-absorbing element and/or resonator, is additionally arranged in the supply line 7 of the nozzle body 8. An acoustic element 11, configured as a sound-absorbing element and/or resonator, is furthermore arranged in the inlet duct 9 of the nozzle body. Not shown, but also conceivable, is an embodiment in which an acoustic element, configured as a sound-absorbing element and/or as a resonator, is arranged only in the supply line 7 or only in the inlet duct 9 of the nozzle body 8.

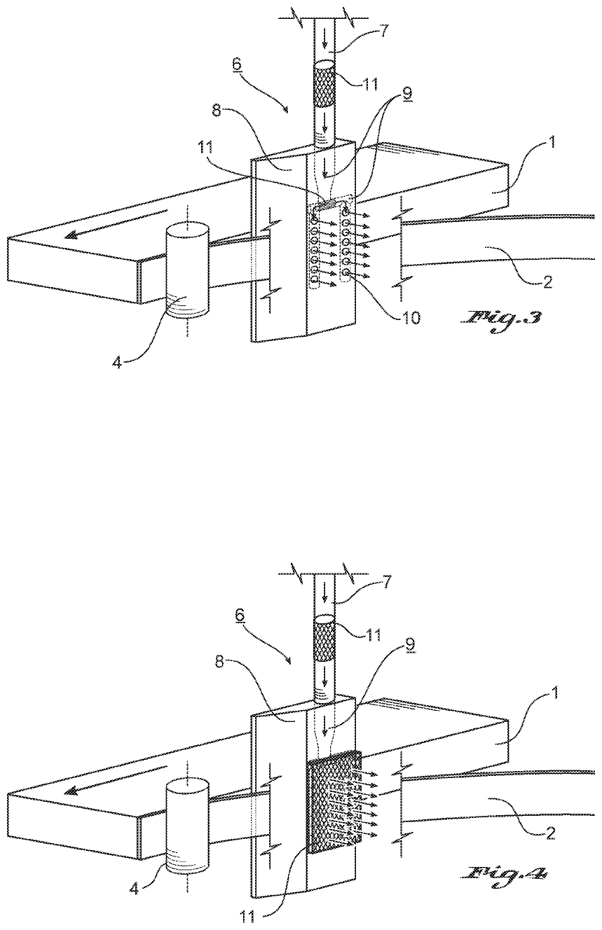

The embodiment of the present invention shown in FIG. 4 differs from the device of FIG. 1 in that an acoustic element 11, configured as a sound-absorbing element and/or resonator, is additionally arranged at the outlet region 10 of the nozzle body. The supply line 7 furthermore comprises an acoustic element 11, configured as a sound-absorbing element and/or as a resonator.

FIG. 5 shows an example of a fabric that can be used as a component of the acoustic element 11. The fabric preferably consists of high-temperature-resistant wire 12, which is processed into a two-dimensional or three-dimensional product and, according to the invention, can be arranged in one or more layers, completely or partially aligned or also stacked in an offset manner.

FIG. 6 shows an example of a grid structure 14 consisting of groups of grid elements 13 each inclined with respect to one another. In the present example, the groups of grid elements 13 form a 90° angle to each other. The shown arrangement of grid elements 13 results in the creation of openings 15, through which an activation medium can flow.

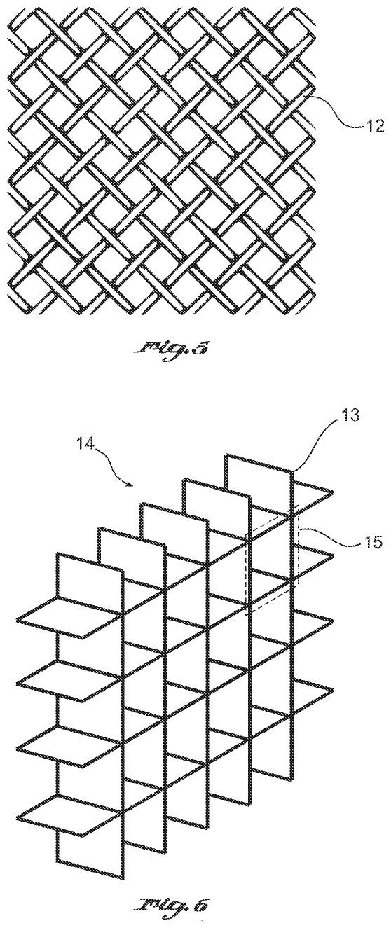

FIG. 7a shows an example of two grid elements 13, each of which comprises notches 17 so that the grid elements can be inserted into one another. An advantageous further development of the grid elements 13 of FIG. 7a, which also uses notches 17, is shown in FIG. 7b. In this figure, the grid elements 13 have a drop-shaped cross-section 16, as a result of which pressure losses during the flow of the activation medium can be reduced.

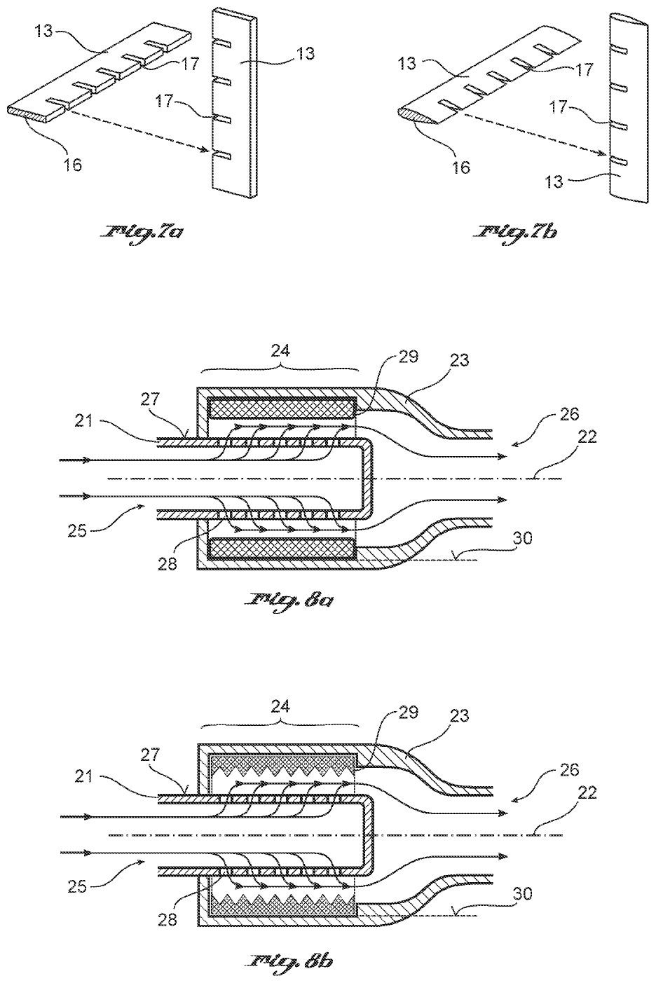

A further advantageous embodiment of an acoustic element 11 according to the invention is shown in an axial cross-section in FIG. 8a. The acoustic element 11 according to the further advantageous embodiment comprises an inner conduit 21 having an axis 22 and an outer conduit 23 arranged substantially concentric to this axis 22. The outer conduit 23 has a larger cross-section than the inner conduit 21. The inner conduit 21 and the outer conduit 23 overlap in a first length region 24. The inner conduit 21 is open at a first end 25 and closed at an end substantially opposite thereto. The outer conduit 23 is open at a second end 26 and closed at an end substantially opposite thereto. The inner conduit 21 has through-holes 28 in its lateral surface 27 that are configured to bring the first end 25 into fluidic connection with the second end 26. A sound-absorbing material 29 is arranged on the inner surface 30 of the outer conduit. When an activation medium flows into the first end, it passes through the through-holes 28 into the region between the inner conduit 21 and the outer conduit 23 and exits the outer conduit at a second end. The sound resulting from the flow of the activation medium is thereby absorbed at least in part by the sound-absorbing material 29.

The third embodiment of an acoustic element according to the invention which is shown in FIG. 8b differs from the embodiment shown in FIG. 8a in that the sound-absorbing material 29 has pointed, for example conical or pyramid-shaped, structures on its surface facing the axis 22. This geometric shape can enhance the sound-absorbing effect beyond the sound-absorbing effect associated with the material.

FIGS. 9a and 9b show components of a third or respectively fourth advantageous embodiment of an acoustic element according to the invention. The acoustic element 11 may specifically comprise spheres 18 arranged in a primitive cubic (FIG. 9a) or body-centred cubic (FIG. 9b) packing.

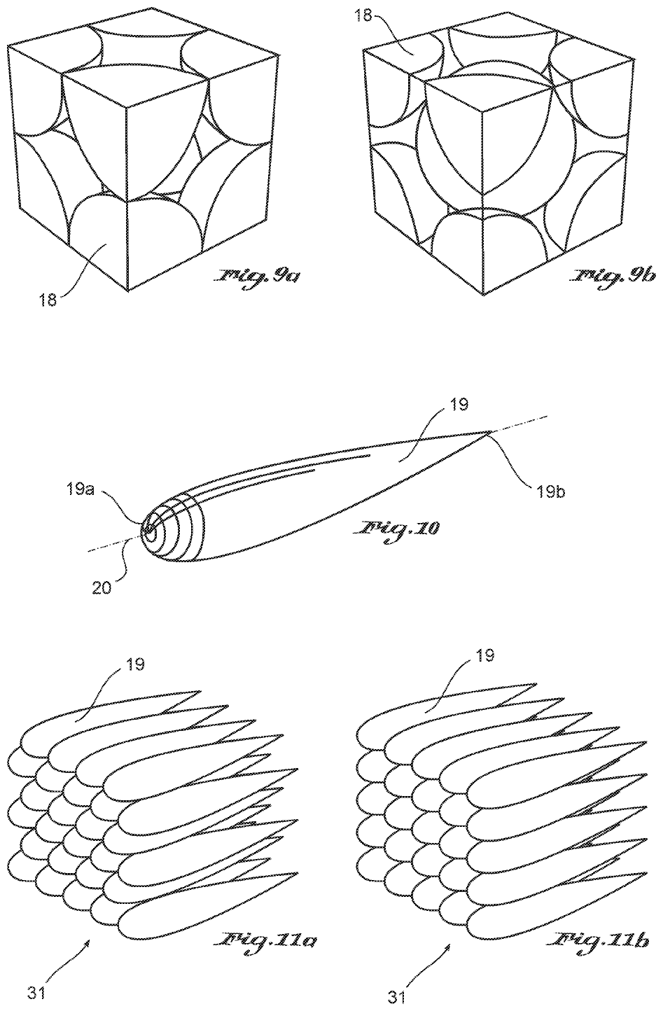

An acoustic element 11 according to the invention may furthermore also comprise streamlined bodies 19, as shown by way of example in FIG. 10. Such streamlined bodies 19 could, for instance, be arranged such that they are offset (FIG. 11a) or stacked vertically (FIG. 11b). The arrangement has a direct effect on the free flow cross-section. A small flow cross-section associated with the offset stacking according to FIG. 11a may be advantageous as regards the sound-absorbing effect of the acoustic element. By contrast, a vertically stacked arrangement according to FIG. 11b may lead to a reduction in pressure and/or velocity losses in the flow of the activation medium as compared to the offset arrangement of FIG. 11a.

### REFERENCE NUMBERS

1 Workpiece
2 Coating material
3 Feed device
4 Pressing device
5 Conveying device
6 Activation device
7 Supply line
8 Nozzle body
9 Inlet duct
10 Outlet region
11 Acoustic element
12 Wire
13 Grid element
14 Grid structure
15 Opening
16 Planar cross-section
17 Notch
18 Sphere
19 Streamlined body
19a Hemispherical end of the streamlined body
19b Pointed end of streamlined body
20 Streamlined body axis
21 Inner conduit
22 Conduit axis
23 Outer conduit
24 First length region
25 First end
26 Second end
27 Lateral surface
28 Through-hole
29 Sound-absorbing material
30 Inner surface of the outer conduit
31 Arrangement of a plurality of streamlined bodies

1. Device for coating workpieces comprising a feed device for feeding a coating material; a pressing device for pressing the coating material onto a surface of a workpiece; a conveying device for inducing a relative movement between the pressing device and the respective workpiece; and an activation device for activating an adhesive on a coating material fed in the feed device and/or for activating an adhesive on a surface of a workpiece to be coated, said activation device comprising at least one supply line for supplying an activation medium as well as a nozzle body having an inlet duct and an outlet region,
wherein the activation device comprises at least one acoustic element that is configured to reduce the sound pressure resulting from the flow of the activation medium and/or to effect a frequency shift.

2. The device according to claim 1, wherein the at least one acoustic element is configured as a sound-absorbing element and/or as a resonator.

3. The device according to claim 1, wherein the acoustic element is arranged at at least one of the locations: supply line of the activation device; inlet duct of the nozzle body; or outlet region of the nozzle body.

4. The device according to claim 1, wherein the activation device comprises at least one activation medium heating device and/or at least one activation medium cooling device and/or an activation medium discharge duct, wherein the acoustic element is arranged in the activation medium heating device, the activation medium cooling device and/or the activation medium discharge duct.

5. The device according to claim 1, wherein the acoustic element comprises a single-layer or multi-layer fabric.

6. The device according to claim 1, wherein the acoustic element comprises a honeycomb structure.

7. The device according to one claim 1, wherein the acoustic element comprises a plurality of grid elements which together form a grid structure with openings, wherein a grid element is formed by parallel displacement of a planar cross-section perpendicular to the cross-sectional plane, and wherein a first plurality of grid elements forms an angle of between 20° and 90°, relative to a second plurality of grid elements.

8. The device according to claim 7, wherein the grid elements comprise notches which are configured such that grid elements that are each angled relative to each other can be inserted into each other.

9. The device according to one of claim 7, wherein the grid elements that are each angled relative to each other are connected to one another with a force fit, form fit and/or cohesive fit.

10. The device according to claim 7, wherein the planar cross-section comprises a round portion and a pointed portion substantially opposite thereto.

11. The device according to claim 7, wherein a plurality of grid structures are stacked such that the openings thereof are at least partially aligned with one another and/or at least partially offset from one another and/or rotated relative to each other.

12. The device according to claim 1, wherein the acoustic element comprises a plurality of spatial substructures, which are arranged in a substantially primitive cubic, body-centred cubic, face-centred cubic or hexagonal close-packed packing.

13. The device according to claim 1, wherein the acoustic element comprises a plurality of streamlined bodies, wherein a streamlined body comprises a substantially hemispherical end and a pointed end opposite thereto, wherein a streamlined body axis extends through said hemispherical end and said pointed end, and wherein said streamlined body axes of all streamlined bodies of the acoustic element are arranged such that they are substantially parallel.

14. The device according to claim 1, wherein the acoustic element comprises a plurality, at least two, of the structures:
grid structure with openings;
honeycomb structure with openings;
single-layer or multi-layer fabric with openings;
sintered structure with openings;
random fibre structure with openings;
an array of spatial substructures, arranged in a substantially primitive cubic, body-centred cubic, face-centred cubic or hexagonal close packed packing, wherein the regions in the array of substructures in which no substructures are formed define openings;
an array of streamlined bodies, wherein a streamlined body comprises a substantially hemispherical end and a pointed end opposite thereto, wherein a streamlined body axis extends through said hemispherical end and said pointed end, wherein the streamlined body axes of all streamlined bodies of the acoustic element are arranged such that they are substantially parallel, and wherein the regions in the array of streamlined bodies in which no substructures are formed define openings;
wherein the structures are stacked such that the openings thereof are at least partially aligned with one another and/or at least partially offset from one another and/or rotated relative to each other.

15. The device according to claim 1, wherein the acoustic element or parts of the acoustic element are made of a metal and/or a ceramic material that is suitable for continuous use at temperatures of up to 900° C.

16. The device according to claim 1, wherein the acoustic element is formed by a casting process, a sintering process or an additive manufacturing process.

17. The device according to claim 1, wherein the acoustic element comprises an inner conduit having an axis and an outer conduit arranged substantially concentric to said axis, said outer conduit having a larger cross-section than said inner conduit, said inner conduit and said outer conduit overlapping in a first length region, wherein the inner conduit is open at a first end and closed at an end substantially opposite thereto, and wherein the outer conduit is open at a second end and closed at an end substantially opposite thereto, wherein the inner conduit has through-holes in its lateral surface that are configured to bring the first end into fluidic connection with the second end, and wherein a sound-absorbing material is arranged in the first length region.

18. The device according to claim 13, wherein the sound-absorbing material is arranged on the inner surface of the outer conduit, wherein a plurality of structures tapering substantially in the direction of the conduit axis are formed on a side of the sound-absorbing material facing the conduit axis, and wherein the sound-absorbing material is porous.

19. The device according to claim 1, wherein the acoustic element arranged in the inlet duct of the nozzle body and/or the acoustic element arranged at the outlet region of the nozzle body attached to the nozzle body with a force fit, a form fit and/or a cohesive fit.

20. The device according to claim 1, wherein
the acoustic element arranged in the inlet duct of the nozzle body and/or the acoustic element arranged at the outlet region of the nozzle body configured integrally with the nozzle body.

21. The device according to claim 1, wherein the acoustic element arranged in the supply line of the activation device is connected to the supply line with a force fit, a form fit and/or a cohesive fit.

22. The device according to claim 1, wherein the acoustic element arranged at the outlet region of the nozzle body is recessed in the nozzle body in a flush-mounted manner.

23. The device according to claim 3, wherein
the mesh size of the fabric and/or grid structure is less than the value 5000 μm.

24. Method for coating and/or activating workpieces using a device according to claim 1, said method comprising the steps of:
inducing a relative movement between the pressing device and the respective workpiece by means of the conveying device;
feeding the coating material by means of the feed device; and
applying and/or activating an adhesive on a coating material fed in the feed device and/or a surface of a workpiece to be coated by means of the activation device.

25. Method for coating and/or activating workpieces using a device according to claim 1, said device comprising at least one sensor for measuring a measurement parameter, said method comprising the steps of:
measuring a measurement parameter; and
changing a working parameter of a processing machine based on the measured measurement parameter.

26. The method according to claim 25, wherein the measurement parameter is a temperature, an atmospheric pressure, a sound pressure, a sound frequency, a fluid viscosity or a Reynolds number, and wherein the working parameter is a feed rate, a flow rate, a heating/cooling power and/or an activation energy.
